(19) United States
(12) Patent Application Publication
(10) Pub. No.: US 2020/0383322 A1
(43) Pub. Date: Dec. 10, 2020

(54) APPARATUS AND METHOD FOR ALTERING THE PROPERTIES OF BLOOD BY PROCESSING THROUGH THE APPLICATION OF A MAGNETIC FIELD

(71) Applicant: DynaPulse, L.L.C., Minnetonka, MN (US)

(72) Inventors: David C. Jiles, Ames, IA (US); Steffen Magnell, Plymouth, MN (US)

(21) Appl. No.: 16/844,784

(22) Filed: Apr. 9, 2020

Related U.S. Application Data
(63) Continuation of application No. 15/450,700, filed on Mar. 6, 2017, now abandoned.
(60) Provisional application No. 62/303,587, filed on Mar. 4, 2016.

(51) Int. Cl. A01N 1/02

(52) U.S. Cl. CPC A01N 1/0294

(57) ABSTRACT

Embodiments include exposing blood to a pulsed magnetic field. Embodiments include exposing blood to a pulsed magnetic field as a means of improving blood viscosity management, blood oxygenation, and banked blood shelf life. Various other embodiments are also included herein.

This application is a continuation of U.S. application Ser. No. 15/450,700, filed Mar. 6, 2017, which claims the benefit of U.S. Provisional Application No. 62/303,587, filed Mar. 4, 2016, the contents of which are herein incorporated by reference

### FIELD OF THE TECHNOLOGY

The present application relates to an apparatus and method for focusing a pulsed magnetic field on blood that can result in affecting the functions and physiology.

### SUMMARY

The effects of focusing a pulsed electromagnetic field on blood viscosity can allow a means of managing blood viscosity. This can reduce or eliminate the need for anticoagulants. This will be accomplished by the application of our proprietary/patent pending technology. Blood is the only fluid tissue in our bodies and viscosity management can be critical to good health.

Red blood cells (RBCs) (Erythrocytes) can respond to the pulsed magnetic field because of cell polarity. Operating at the molecular level, the intensity and duration of the pulsed magnetic field can control or reduce the blood's viscosity thereby increasing the flow through the veins, arteries, and capillaries of the vascular system.

The oxygenation potential of the red blood cells and the iron atom can be improved by a combination of RBCs polarity and stimulation of the iron molecule increasing its oxygen-carrying capability, such as because of the enhanced viscosity and impact of the electromagnetic field. The iron atom center can be the main component that actually binds to oxygen thus each hemoglobin molecule can be able to carry four molecules of oxygen or O2 (oxygen). Thickening of the blood (viscosity), such as when blood is not exposed to the pulsed electromagnetic field, can reduce the flow and the oxygen transfer capability of the red blood cells.

In various embodiments, blood that is stored outside of the body, such as at blood banks or hospitals can be exposed to a pulsed electromagnetic field. Reduced or insufficient transfusion efficacy can result from RBCs being damaged by storage lesion, which is a biochemical and biomechanical change that can occur during storage. Current technology does not provide rejuvenation capable of reversing this phenomenon. Currently, the maximum shelf life is about 42 days for RBC units. Many physicians imply a “restricted protocol” and hospital blood banks will attempt to accommodate a physician's requests for low aged RBC product for certain types of critical patients (e.g. cardiac surgery).

Pulsed electromagnetic technology can increase the shelf life of the blood product resulting in increased product quality and patient safety. Tests measuring the erythrocyte fragility, erythrocyte deformability, and viscosity measurements can provide in vitro tests to measure the viability of the red blood cells.

The combination of electrical stimulation and focused pulsed magnetic treatment of the blood flow can provide management of blood viscosity and greater oxygenation potential of the hemoglobin. As a consequence nutrients and hormones can be distributed to the organs and tissues quicker and more efficiently. Organs and muscle tissues can have an improved fresh supply of oxygen and nutrients supplied by the blood.

In Injuries or illness where the bloodstream is provided with a regular fresh supply of oxygen, nutrients, and endorphins the healing process can be quicker and pain reduced by the body's pain killing hormones. There has been evidence of this in treatment of bone fractures and other trauma induced injuries. Applying a pulsed magnetic field to the blood can increase the effectiveness of the oxygen supply, nutrients, and endorphins at significantly higher levels in that experienced by patients with venous stasis, deep vein thrombosis (DVT) or peripheral arterial disease (PAD).

Postsurgical recovery can be enhanced by the application of the pulsed electromagnetic field to blood, which can enhance circulatory efficacy (through viscosity management, greater oxygenation) thereby lowering the potential for pulmonary embolisms, ischemic strokes, hemorrhagic strokes, and other postoperative threats. This can be a critical problem in orthopedic surgery, vascular surgery, and related invasive procedures.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE FIGURES

The technology may be more completely understood in connection with the following drawings, in which:

FIG. 1 shows a viscosity curve of blood, according an embodiment.

FIG. 2 shows the effects of anemia.

FIG. 3 shows a diagram of oxygen entering and leaving red blood cells.

FIG. 4 shows a diagram of capillary exchange.

FIG. 5 shows a diagram of blood pressure values.

FIG. 6 shows standard blood shelf lives.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

The present invention is directed to a method for altering the properties of blood by exposing the blood to a magnetic field, comprising generating a magnetic field; exposing blood to the magnetic field; and determining the optimum values for the amplitude and frequency of the magnetic field in order to alter properties of the blood.

In an example implementation, the invention is directed to a method for improving blood viscosity. In an example implementation, the invention is directed to a method for improving the oxygen carrying capability of the blood. In an example implementation, the invention is directed to a method for improving the shelf life of blood.

In the present invention, blood is exposed to a magnetic field. In one embodiment, the magnetic field may be time-varying. In another embodiment, the magnetic field may be time invariant. The magnetic field may be generated in any number of ways, including through the use of coils or other devices carrying an electric current or through the use of one or more permanent magnets. By exposing blood to the magnetic field any number of the properties of the blood may be altered, including, but not limited to, the viscosity, the oxygen carrying capability, and the shelf life.

In one embodiment, the present invention is directed to a system for subjecting blood to a magnetic field for the purpose of altering the properties of the blood, comprising: a coil configured to generate a magnetic field; a pulse generator configured to generate a waveform; and a power supply configured to generate a current in the coil.

A magnetic field generator can be used to generate a magnetic field around the blood. In an embodiment, the magnetic field generator produces a pulsed magnetic field.

In one embodiment, the magnetic field generator may be an external wand for generating a magnetic field around the blood to be treated. In another embodiment, the magnetic field generator may be a cylindrical chamber or be a chamber with a clam shell design. In yet another embodiment, the magnetic field generator may be a coil wrapped around the blood to be treated. The magnetic field generator may comprise a power supply and a pulse generator to provide a pulsed magnetic field.

In one embodiment, the average strength of the magnetic field varies from 6 to 20 G (wherein G refers to the unit of gauss). Where a magnetic field generator is a coil, the average field strength may be approximately 6 G at the center of the coil and around 20 G around the edges of the coil. In another embodiments, the average magnetic field strength ranges from 6 to 40 G with a field strength of 6 G at the center of the coil and around 40 G around the edges of the coil. These ranges are also applicable where the magnetic field generator is not coil.

Magnetic fields can have different effects on blood depending on the type of field exposure. Magnetic fields to which blood may be exposed may either be constant or pulsed. The field exposure may be from a direct current (DC) or alternating current (AC) source and may vary by amplitude, frequency, or waveform.

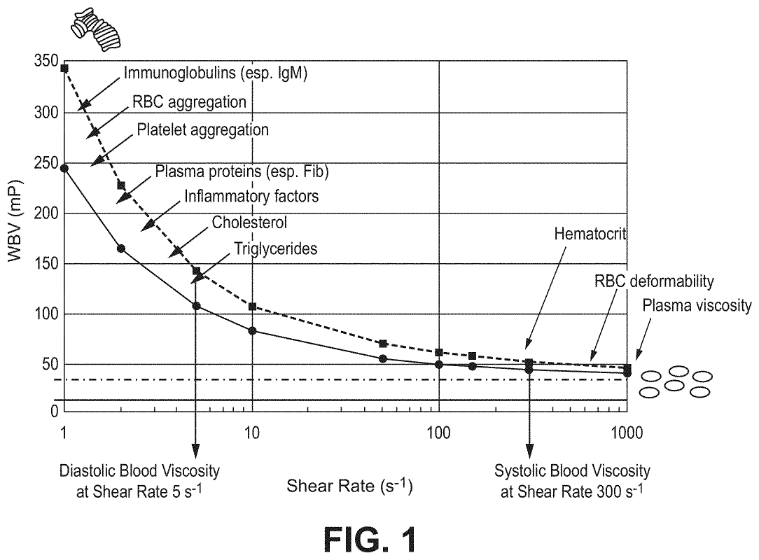

In an embodiment, a focused pulsed magnetic field can be applied to blood, such as to optimize the viscosity of the blood. In various embodiments, the focused pulsed magnetic field can reduce blood viscosity. FIG. 1 shows the normal curve for the blood viscosity of a healthy male.

Blood viscosity can refer to blood thickness and stickiness. It can be a direct measure of the ability of blood to flow through the vessels. It can also be a key screening test that measures how much friction the blood causes against the vessels, how hard the heart has to work to pump blood, and how much oxygen is delivered to organs and tissues. High blood viscosity can be easily modifiable with safe lifestyle-based interventions.

Blood viscosity can be defined as the inherent resistance of blood to flow. Normal adult blood viscosity can be about 40/100, which is read as “forty over one hundred” and reported in units of millipoise (mP).

Increased blood viscosity is the only biological parameter that has been linked with all of the other major cardiovascular risk factors, including high blood pressure, elevated low density lipoprotein (LDL) cholesterol, low high density lipoprotein (HDL), type-II diabetes, metabolic syndrome, obesity, smoking, age, and male gender.

In some cases people might be tempted to think of blood simply as a transportation system for the body's organs or as a hydrating fluid, but it is important to remember that the blood is an organ in and of itself: a very large collection of living cells that interact with one another. The blood can be 3-4 times larger by volume than the brain, and 2-3 times larger than the liver.

Blood can be a vigorous organ insofar as it behaves as a non-Newtonian fluid, which means that its viscosity changes as a function of shear rate. Shear rate can be related to the velocity. When blood moves quickly as in peak-systole, it is physically thinner; when it moves slowly during end-diastole, it is thicker and stickier. This is because red cells aggregate. The phenomenon is known as the shear-thinning, non-Newtonian behavior of whole blood.

FIG. 1 shows viscosity curves for two apparently healthy males, both with hematocrit of 45. The dotted line is a constant viscosity of 35 mP, depicting a Newtonian fluid, and the blue line is the viscosity of water at 10 mP. Human blood viscosity varies dynamically from the left-side of FIG. 1 to the right-side and back again during each cardiac cycle. At systole (high shear rate), blood can be thinner, while at diastole (low shear rate), blood can be 2-5 times thicker.

The largest blood viscosity study ever conducted was part of the Edinburgh Artery Study in the 1990s, which followed a random population of 1,592 middle-aged adults for a mean of 5 years. It showed that blood viscosity, after adjustment for age and gender, was significantly higher in patients experiencing heart attacks and strokes than those who did not (p=0.0003). The 20% of the individuals with the highest viscosity had 55% of the heart attacks and strokes during the 5-year period. In contrast, only 4% of those in the lowest viscosity group had any significant events.

In various embodiments, exposing blood to a focused pulsed magnetic field can improve or increase the oxygenation of the red blood cells or hemoglobin. (Hemoglobin is the protein molecule in red blood cells that carries oxygen from the lungs to the body's tissues and returns carbon dioxide from the tissues back to the lungs.) Within the (remove—the) hemoglobin the iron molecule is the molecule that carries the (remove—the) oxygen to be vital organs. It is the iron molecule that binds oxygen as the blood travels between the lungs and the tissues. There are four iron atoms in each molecule of hemoglobin, which accordingly can bind four atoms of oxygen. Globin consists of two linked pairs of polypeptide chains.

In various embodiments, exposing blood, such as blood at a blood bank, to a focused pulsed magnetic field can increase the shelf life of the blood product at the hospital blood blank or commercial blood bank. A focused pulsed electromagnetic field can be incorporated into the storage systems of the blood bank and provide treatment for the blood on a scheduled periodic basis to increase shelf life from 42 days to a multiple of previous protocol. Additionally, it can allow physicians greater access to an improved and predictable quality of blood.

Blood transfusions are an important part of hematologic care. Transfusion is the transfer of blood, its components, or products from one person (donor) into another person's bloodstream (recipient). Every year in the U.S., more than 20 million units of red blood cells, platelets, and plasma are transfused to treat hematologic conditions such as severe anemia, leukemia, and sickle cell disease. Transfusions have long been associated with risk to patients.

Despite significant progress in ensuring the safety of donated blood, little progress has been made toward extending its shelf life or effectiveness. While the Food and Drug Administration approves the use of donated red blood cells up to 42-days old, research conducted at the Cleveland Clinic between June 1998 and January 2006 confirms that “transfusion of red cells that had been stored for more than two weeks were associated with a significantly increased risk of postoperative complications as well as reduced short-term and long-term survival.

Recent developments have focused on methods for storing red blood cells by providing additive solution that creates a suspension of red blood cells. Oxygen levels are depleted and the storage process in the suspension.

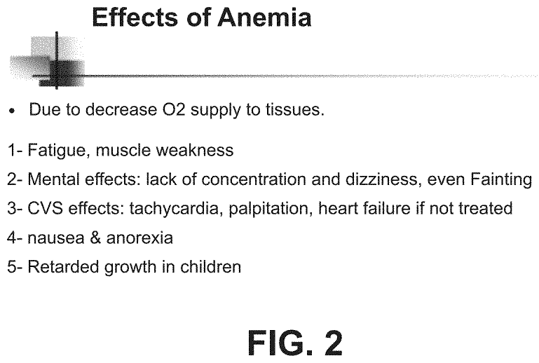

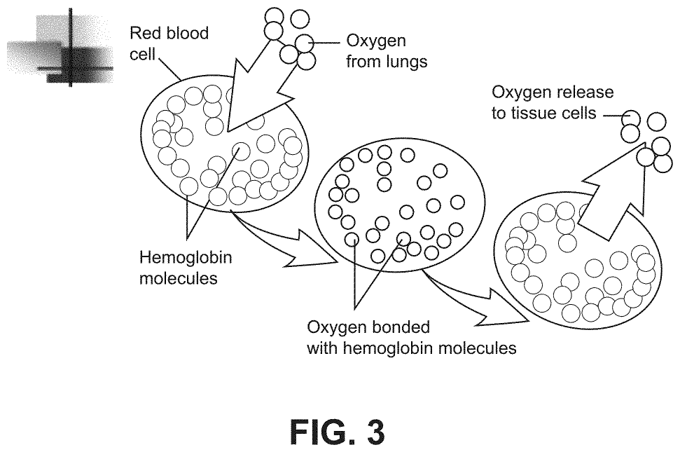

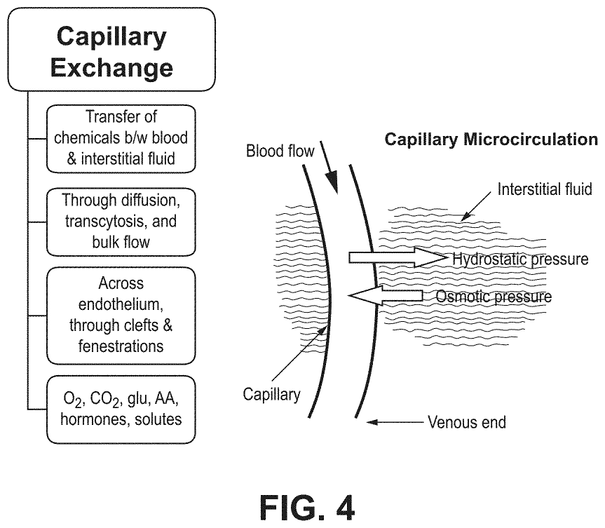

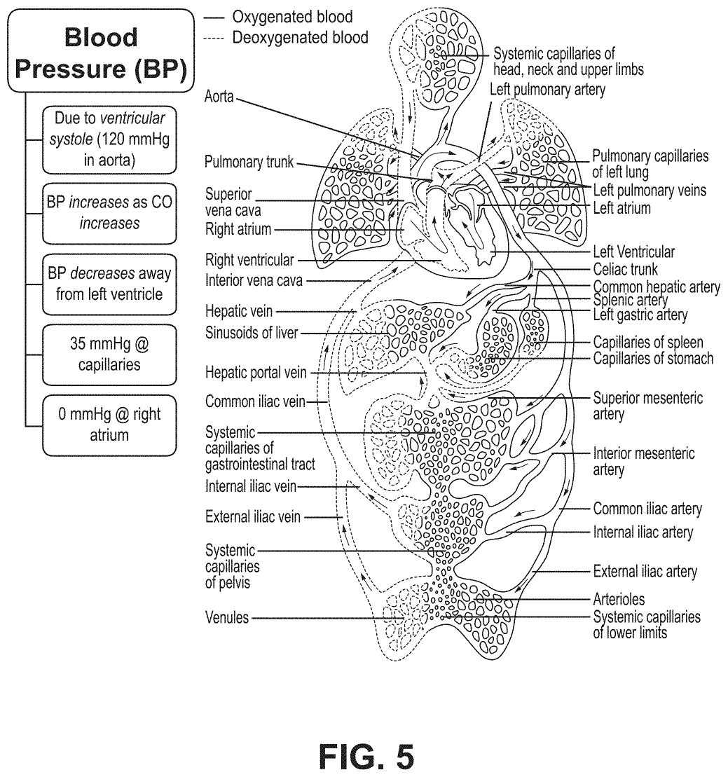

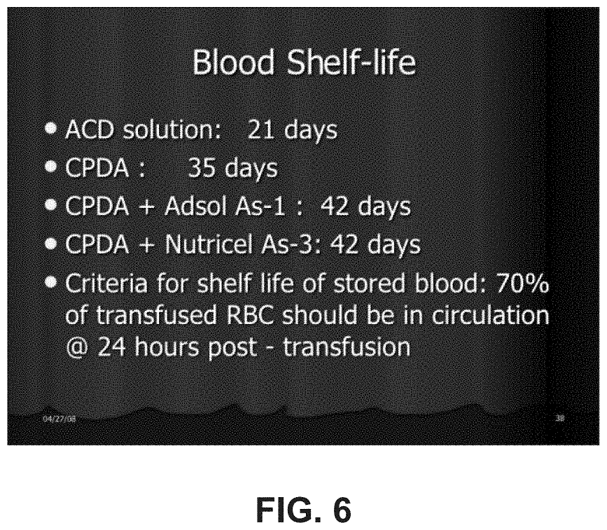

FIGS. 2-6 show information relating to blood. FIG. 2 shows the effects of anemia. FIG. 3 shows a diagram of oxygen entering and leaving red blood cells. FIG. 4 shows a diagram of capillary exchange. FIG. 5 shows a diagram of blood pressure values. FIG. 6 shows standard blood shelf lives.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

The claims are:

1. A method for altering the properties of blood, comprising:
Exposing blood to a generated pulsed magnetic field for a period of time.
